(19) United States
(12) Patent Application Publication
(10) Pub. No.: US 2020/0111392 A1
(43) Pub. Date: Apr. 9, 2020

(54) Automated Sign Rider And Sign System Using Same

(71) Applicant: Jayson Tyler Wagnermarsh, Santa Cruz, CA (US)

(72) Inventor: Jayson Tyler Wagnermarsh, Santa Cruz, CA (US)

(21) Appl. No.: 16/595,344

(22) Filed: Oct. 7, 2019

Related U.S. Application Data
(60) Provisional application No. 62/741,541, filed on Oct. 5, 2018.

(51) Int. Cl. G09F 9/35; G06Q 30/02

(52) U.S. Cl. CPC G09F 9/35; G06Q 30/0261

(57) ABSTRACT

A real estate sign system incorporating a sign rider which can change its text without being removed and replaced. An electronic sign rider which can change its lettering. A sign rider system which allows for remote changing of the textual indicators on the sign rider, which may indicate the sales status of a real estate listing. A sign rider system which allows for remote changing of a plurality of sign riders in different locations.

### CROSS-REFERENCE TO RELATED APPLICATIONS

This application claims priority to U.S. Provisional Patent Application No. 62/741,541 to Wagnermarsh, filed Oct. 5, 2019, which is hereby incorporated by reference in its entirety.

### FIELD OF THE INVENTION

This invention relates to real estate signs, namely an electronic sign rider and system.

### BACKGROUND

When a property, such as a home, is for sale, a sign indicating that the property is for sale is typically installed. The sign may be semi-permanently installed, such as by digging a mounting post into the ground.

The real estate sign may include a hanging placard which gives the contact information of the listing agent or brokerage offering the house for sale. The hanging placard may hang from a horizontal post, which may be coupled to a vertical mounting post. A second, smaller, placard may be placed on top of the horizontal post, and is called a sign rider. Whereas the real estate sign and its hanging placard with the listing agent information may remain constant over a period of time, the sign rider may be periodically changed to indicate different circumstances, such as when a property has a pending sale.

Sign riders which are changed to indicate different circumstances are usually require a visit to the sign's location, and the manual changing of the sign rider.

What is needed is a sign rider which can be modified to indicate changes in circumstance relating to the property without physically removing the sign rider, and that can be so modified remotely. What is also needed is a system which allows a user to change a plurality of sign riders remotely.

### BRIEF DESCRIPTION OF THE DRAWINGS

FIG. 1 is an illustration of a sign with a sign rider.

FIG. 2 is a perspective view of a real estate sign with a sign rider according to some embodiments of the present invention.

FIG. 3 is a perspective view of a real estate sign with a sign rider according to some embodiments of the present invention.

FIG. 4 is a perspective view of a real estate sign with a sign rider according to some embodiments of the present invention.

FIG. 5 is a perspective view of a sign rider according to some embodiments of the present invention.

FIG. 6 is a perspective view of a sign rider according to some embodiments of the present invention.

FIG. 7 is a perspective view of a sign rider according to some embodiments of the present invention.

FIG. 8 is a perspective view of a sign rider according to some embodiments of the present invention.

FIG. 9 is a sketch of a sign rider system according to some embodiments of the present invention.

FIG. 10 is a sketch of a sign rider electronic application according to some embodiments of the present invention.

### SUMMARY

A real estate sign system incorporating a sign rider which can change its text without being removed and replaced. An electronic sign rider which can change its lettering. A sign rider system which allows for remote changing of the textual indicators on the sign rider, which may indicate the sales status of a real estate listing. A sign rider system which allows for remote changing of a plurality of sign riders in different locations.

### DETAILED DESCRIPTION

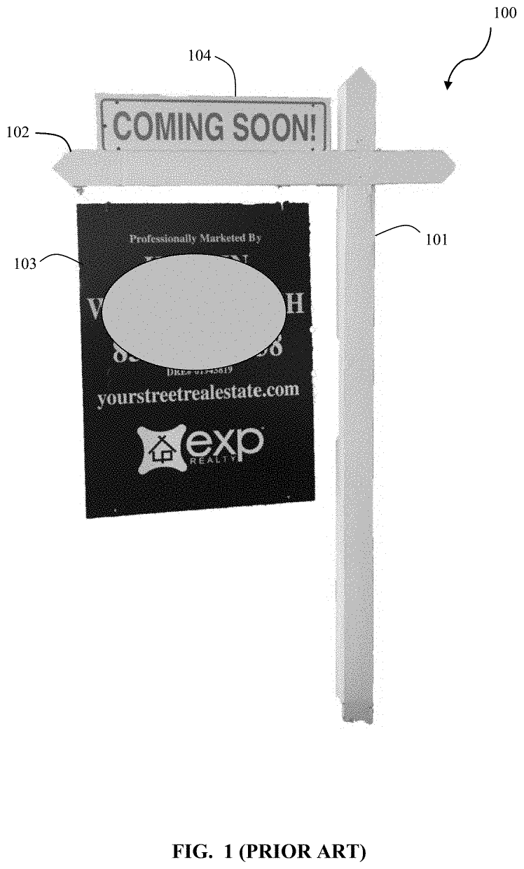

FIG. 1 illustrates a prior art real estate sign system 100. The sign system 100 may include a vertical mounting post 101 coupled to a horizontal bar 102. A placard 103 may hang from the horizontal bar 102. A sign rider 104 resides in position across the top of the horizontal bar 102. As seen in this illustrative example, the hanging placard 103 may provide information regarding the real estate broker involved with selling the property, including contact information. The sign rider 104 may convey a different type of detail, such as “Coming Soon!” as seen here. While the information in the hanging placard 103 may remain constant over the course of time, the details relayed by the sign rider may change periodically. For example, the sign rider may indicate the sales status of a home being offered for sale, such as that a sale is pending, or that a sale has taken place. The sign rider 104 may be periodically replaced with a different piece which indicates the differing detail. This would require a visit to the sign by a person, and the physical replacement of the sign rider.

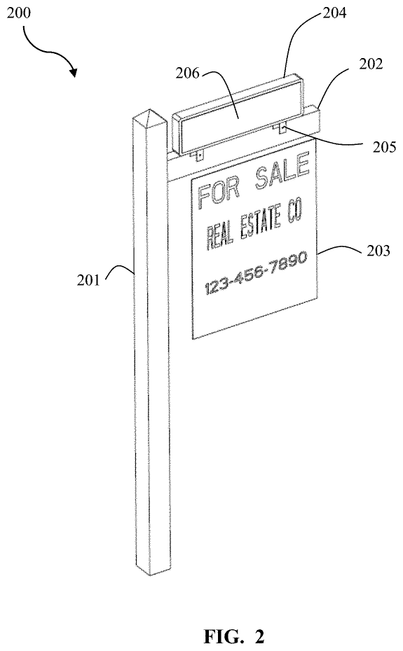

In some embodiments of the present invention, as seen in FIG. 2, a real estate sign system 200 may include a changeable sign rider 204, which may be an electronic sign rider. The sign rider 204 may be coupled to the horizontal bar 202 with attachments 205. The sign system 200 may include a vertical mounting post 201 coupled to a horizontal bar 202. A placard 203 may hang from the horizontal bar 202. The hanging placard 203 may provide information regarding the real estate broker involved with selling the property, including contact information.

The sign rider 204 may include an electronic display space 206. In some aspects, there may also be another electronic display space 206 on the other side of the sign rider 204. In some aspects, the sign rider 204 may include internal aspects which allow for the display on the display space 206. In some aspects, the display space may use a changeable lighting display information. In some aspects, the display may use LED lighting to display one or more text or graphical images. In some aspects, the display may use one or more liquid crystal display (LCD) to display one or more text or graphical images. In some aspects, the display may use an internal mechanical system to display a variety of text or graphical displays.

In some aspects, the sign rider 204 has an electronics portion coupled to the display space. The electronics portion may include control electronics adapted to drive the display panel, such as an LCD panel display. The electronics portion may be adapted to reside within the overall sign rider. In some aspects, the electronics portion may reside exterior to the sign rider. The electronics portion is adapted to receive signals from the sign rider system in order to alter the display. The electronics portion may also send signals to the system to relay status information regarding the sign rider. The status information may include the displayed information (if any), the battery charge status (for a battery driven system), and other information.

In some aspects, the sign rider may include some solar cells or a strip of photovoltaic material adapted to provide solar derived power to the sign rider. In some aspects, the sign rider may include a battery, which may be a rechargeable battery. The photovoltaic portion may assist in keeping the battery or batteries charged, allowing for remote functioning of the sign rider for an extended period of time.

In some aspects, the electronics portion of the sign rider may be split and a portion may reside away from the sign rider, and be coupled to the sign rider with a wired or wireless connection. For example, a portion of the electronics portion of the sign rider may reside inside the residence being listed for sale, and may be powered by the house voltage and coupled to the internet via connection within the house. In some aspects, this may be via wired internet connection, a wireless interconnection, or via a cellular telephone network. The electronics portion may then be coupled to the sign rider with a wired or wireless connection. In some aspects, the connection from the electronics portion to the sign rider may be via a wireless connection such as a Bluetooth connection.

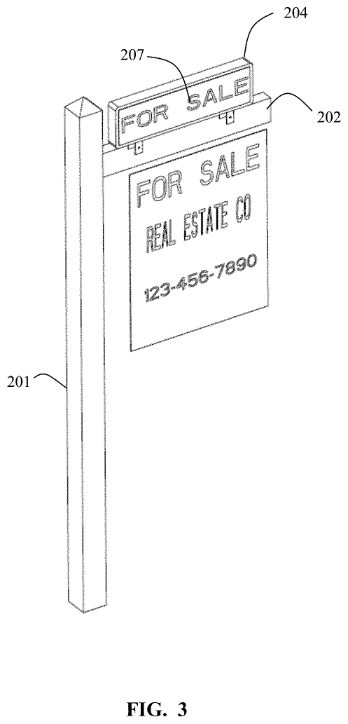

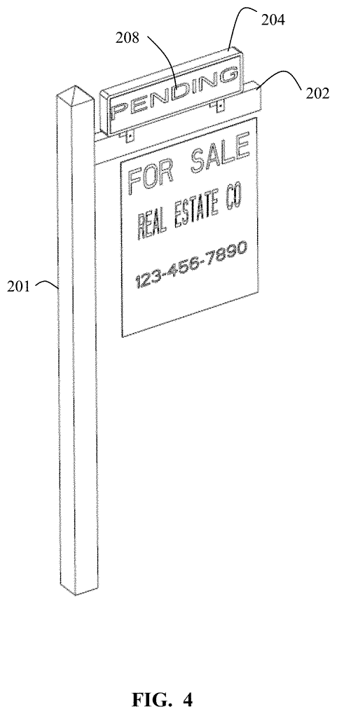

In some aspects, as seen in FIG. 3, the sign rider 204 displays a “For Sale” message 207 in the display space 206. In some aspects, as seen in FIG. 4, the sign rider 204 displays a “Pending” message 208 in the display space 206. These types of status may be referred to as the sales status of the home or other real estate item that the sign is being used to advertise.

In some embodiments, the sign rider 204 may include wireless connectivity to a network, such as the internet. In some aspects, the sign rider may be coupled to the network over a cellular telephone network. In some aspects, the sign rider may be coupled to the network using a wireless distribution method, which connects to the internet through an access point. In some embodiments, a sign rider system resides in a server or other storage device. The sign rider system may include software adapted to implement the functionalities of the overall system. The sign rider system may include software residing within a computer system. The sign rider system allows access by a user to view the display status of one or more sign riders in place at one or more locations. In some aspects, the sign rider system allows for a user to change the display seen in the display space of a sign rider. In some aspects, the user first accesses the sign rider system, and then is able to select a particular sign rider able to be contacted by the sign rider system, and then is able to change the display seen in the display space of a sign rider. In some aspects, the sign rider system allows for control over the display spaces in a plurality of sign riders, which may be in different locations.

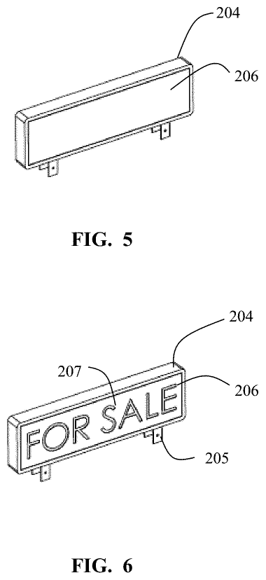

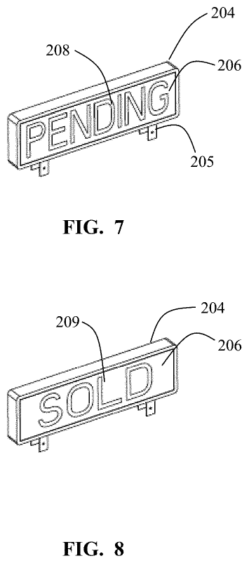

In some embodiments of the present invention, as seen in FIGS. 5-8, a sign rider 204 with attachment portions 205 may have a display space 206. In some aspects, there is a display space 206 on either side of the sign rider 204. The sign rider 204 may include wireless and/or cellular connectivity to a network, which may allow a use to change the display seen in the display space 206. In some aspects, the display space 206 may include a lighting display space which may be used to display text or graphical messages. In some aspects, the lighting display space may use LED lighting to display such messages. A sign rider according to embodiments of the present invention allows a traditional real estate sign to be retrofitted with an electronic sign rider while maintaining the look and feel of a traditional real sign, to which the public may have become accustomed.

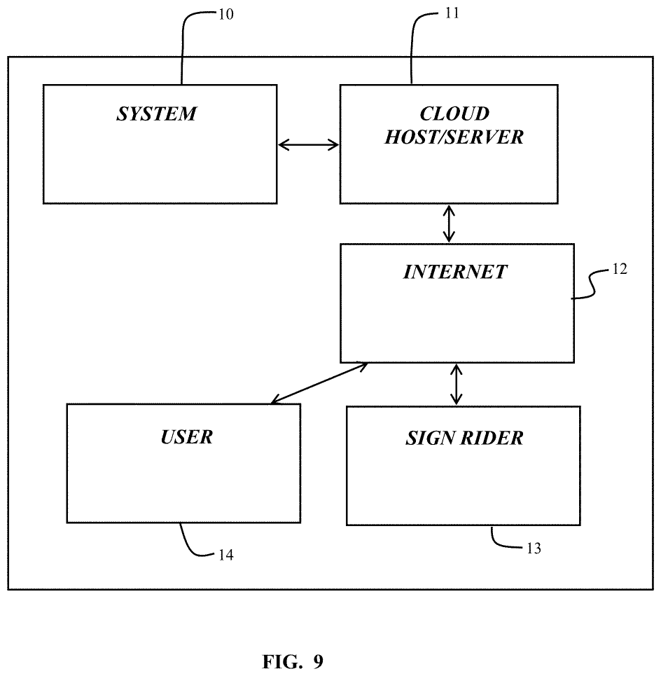

In some embodiments of the present invention, as seen in FIG. 9, a sign rider system may include an electronic system 10 which may include programming for the communication to and control of a plurality of sign riders 13. The electronic system 10 may be coupled to a server or cloud host 11 in some aspects. The server 11 may be coupled to the internet 12. A user 14 may be able to communicate to the system 10 using wireless internet access or cellular communication. One or more sign riders 13 may be coupled to the system 10 using wireless internet access or cellular communication.

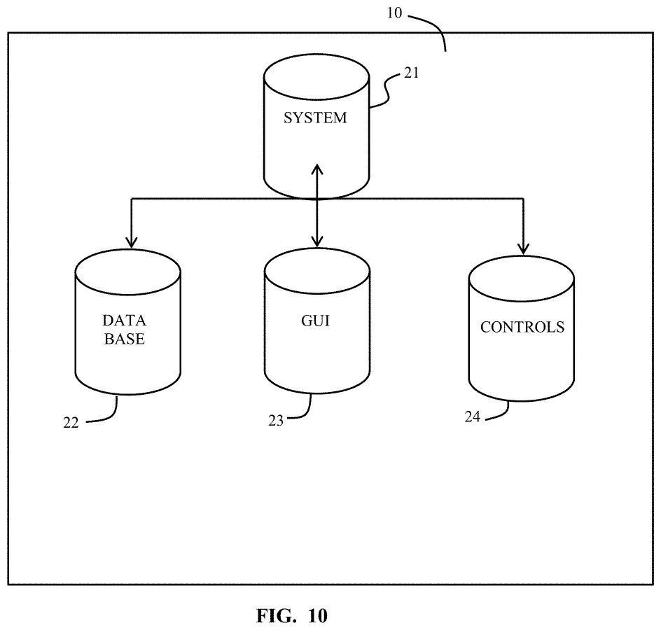

FIG. 10 illustrates aspects of the electric system 10 according to some embodiments of the present invention. The system 10 may include a computer processor and may include computer readable instructions for the operation of the sign rider system. The system 10 may use and maintain a database 22 which includes sign locations, access codes, and other information important to the system. The database may have a user access information section which stores information regarding authorized users, including password information and other information. The database may have a sign information portion which lists all signs coupled to the system, including display status information, listed home information such as address, home type, and other information. The sign information may also include site specific status information, such as operational status, battery charge status, charging capability status, and other information. The database may be stored in a computer readable format on a computer system and adapted to be accessed by the computer system 10.

A graphical user interface portion 23 may allow an interactive application to be easily operated by a user. A user may access the GUI and then view information regarding signs on the system. The user may also use the GUI to alter the display status of a selected sign. User access via the GUI may be limited to authorized users. A control portion 24 may include instructions for different sign display messages, including allowing for the use of customized messages. A system image 21 may include instructions for operation of the overall electric system.

A user accessing the system may interact with the user interface portion to select a sign (at a particular location). The sign information may reside in a database section which contains the location, the display status, and other information for every sign able to be controlled by the system. The selected sign's information may be accessible and viewable by the user. The user may then select an operation to implement, such as changing the display of the selected sign. When the user inputs the selected operation instructions, such as changing the display on the sign rider from “For Sale” to “Pending”, for example, the control portion 24 may then send the proper electronic signals which result in the change of the sign's display. The signal may be sent by the appropriate method for that sign, which may be via a cellular network, for example. In some aspects, the control portion will send a signal via a cellular network that is received by the electronic portion of the sign rider. The electronic portion of the sign rider then interprets that signal and sends signals to the display to effectuate the change to the display.

In some aspects, the user may access the system using a computer or a cellular telephone, such as a smartphone. The user may use a cellphone to access the internet, for example, and then to access the automated sign rider system.

In an exemplary embodiment of the electric system 10, an authorized user 14 may interact with the system 10. The user 14 may activate a sign rider 13 with a particular message, such as “pending”, for example. The user 14 may also access the system to check on the status of other sign riders at the same or other locations.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A real estate sign rider system, said system comprising:
a vertical mounting post;
a horizontal bar coupled to said vertical mounting post; and
an electronic sign rider, said electronic sign rider coupled to said horizontal bar, said sign rider comprising:
an electronic display space adapted to display a plurality of messages;
an electronics portion coupled to said display space, said electronics portion adapted to communicate with a wireless network.

2. The real estate sign rider system of claim 1 wherein said electronic sign rider resides above said horizontal bar.

3. The real estate sign rider system of claim 1 wherein said electronics portion is adapted to command said display space to display sales status.

4. The real estate sign rider system of claim 1 wherein said electronic display space comprises and liquid crystal display panel.

5. The real estate sign rider system of claim 3 wherein said electronic display space comprises and liquid crystal display panel.

6. The real estate sign rider system of claim 1 further comprising a computer system, wherein said computer system is adapted to communicate with said computer portion via a wireless network.

7. The real estate sign rider system of claim 1 wherein said electronic sign rider further comprises a battery.

8. The real estate sign rider system of claim 7 wherein said electronic sign rider further comprises a photovoltaic portion coupled to said electronics portion.

9. An automated sign rider, said automated sign rider comprising:
a display space adapted to display a plurality of messages;
an electronics portion adapted to communicate with a wireless network.

10. The real estate sign rider system of claim 9 wherein said electronics portion is adapted to command said display space to display sales status.

11. The real estate sign rider system of claim 9 wherein said electronic display space comprises and liquid crystal display panel.
